(19) United States
(12) Patent Application Publication
(10) Pub. No.: US 2005/0260343 A1
(43) Pub. Date: Nov. 24, 2005

(54) Methods for manufacturing large-scale plastic lenses

(76) Inventor: Chih-Chiang Han, Taichung (TW)

Correspondence Address: DELLETT AND WALTERS, P. O. BOX 2786, PORTLAND, OR, 97208-2786, US

(21) Appl. No.: 10/851,525

(22) Filed: May 20, 2004

(51) Int. Cl. B05D 5/06

(52) U.S. Cl. 427/164

(57) ABSTRACT

Methods for manufacturing large-scale plastic lenses that cut a plastic optical material piece into a non-spherical lens by use of an accurate CNC lathe turning machine cooperating with a curve adjusting program to correct variations caused in the following steps. After cutting, the non-spherical lens is coated with hardening membranes or/and selectively polished to improve surface quality of surfaces of the non-spherical lens. Lastly, anti-reflecting membranes coat on the hardening membranes to achieve a large-scale plastic lens. By the methods, manufacturing procedures of the large-scale plastic lens are simplified to save time and to reduce manufacturing costs.

### BACKGROUND OF THE INVENTION

1. Field of the Invention

The present invention relates to methods for manufacturing large-scale plastic lenses, and more particularly for manufacturing methods that produce lenses that serve as projecting lenses or receiving lenses in wireless optical communication or magnifying glasses in large telescopes.

2. Description of Related Art

With mushrooming development in wireless communications, free space optical communication is becoming more and more important in the wireless technology. To briefly introduce the free space optical communication, a data signal is transformed into a laser signal to transmit from a projecting device, to pass through air linearly without obstruction, and to be received in a receiving device. The transmitted laser signal is then re-transformed back to original readable data signal. Advantages of the free space optical communication are wide bands, high transmitting rate, low cost etc. Most compliable devices adapted to the free space optical communication have been developed to maturity, however, the quality of lenses on the projecting and receiving devices still have a great influence in controlling transmitting efficiency of the free optical communication.

Because a laser beam radiates and spreads out to cover a large area after traveling a long distance, the lens of the receiving device must be in large scale. For example, the laser beam of 1 mrad in divergence angle is deformed into 1 meter diameter light spot after traveling over one kilometer distance, the lens of the receiving device must be large enough over one meter diameter to receive all light spot to complete the laser signal.

Additionally the surface of the large-scale lens is an important factor for receiving the laser signal. All surfaces of the large lenses are non-spherical and that can not be achieved by existing polishing methods. A conventional manufacturing method for large-scale lenses is that multiple small spherical surface lenses are combined together into a large-scale lens. However, each spherical surface lens has to be manufactured individually in a mold and adjusted precisely to make the combined large scale lens have excellent focusing efficiency. Therefore, the conventional manufacturing method for large-scale lenses is time-consuming and troublesome. Additionally, the mold is very high cost and that accordingly increases costs of the large-scale lenses.

To overcome the shortcomings, the present invention provides multiple methods for manufacturing large-scale plastic lenses to mitigate and obviate the aforementioned problems of the conventional manufacturing method.

### SUMMARY OF THE INVENTION

The main objective of the invention is to provide multiple methods for manufacturing large-scale plastic lenses, which simplify the manufacturing procedures and decrease manufacturing costs of the large-scale lenses.

Other objectives, advantages and novel features of the invention will become more apparent from the following detailed description when taken in conjunction with the accompanying block diagrams.

### BRIEF DESCRIPTION OF THE DRAWINGS

FIG. 1 is a functional block diagram of a first method for manufacturing large-scale plastic lenses in accordance with the present invention;

FIG. 2 is a functional block diagram of a second method for manufacturing large-scale plastic lenses in accordance with the present invention; and

FIG. 3 is a functional block diagram of a third method for manufacturing large-scale plastic lenses in accordance with the present invention.

### DETAILED DESCRIPTION OF PREFERRED EMBODIMENT

A method for manufacturing large-scale plastic lens in accordance with the present invention comprises the following acts:
obtaining a plastic optical material piece;
cutting the plastic optical material piece into a non-spherical lens by accurate CNC lathe cutting, wherein the CNC lathe cutting further cooperates with a curve adjusting program to correct the curve errors caused in the following steps to reach a desired surface precision of the non-spherical lens;
coating hardening membranes on surfaces of the non-spherical lens;
optionally, mechanically polishing the surfaces of the non-spherical lens; and
coating anti-reflecting membranes on the hardening membranes to achieve the large-scale plastic lens.

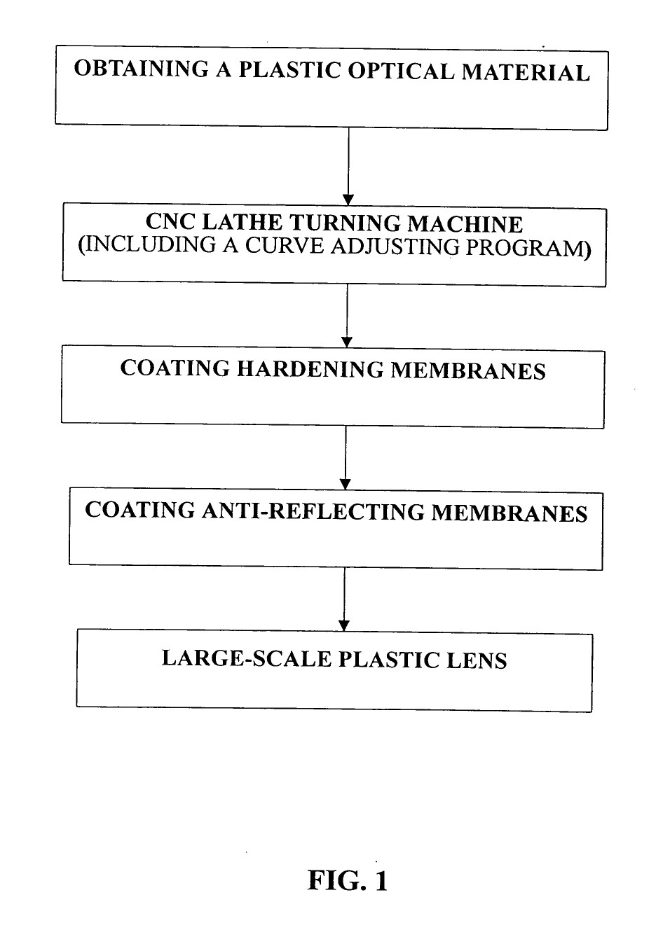

FIG. 1 shows functional blocks of a first preferred embodiment of the method in the present invention. In the act of obtaining the plastic optical material piece, the plastic optical material piece is made of polymethyl methacrylate (PMMA) plate or polycarbonate plate. Particularly, the polymethyl methacrylate plate is the preferred choice because it has a high transparency rate of about 92% to keep the plate still transparent even when the plate is thick.

The polymethyl metharcylate plate is cut by extremely accurate CNC lathe turning machine that cooperates with CAD/CAM programs to make a rough large-scale lens. The CAD/CAM programs instruct the CNC lathe turning machine to run in a certain path to modify the surface of the rough lens into a non-spherical lens. The accurate CNC lathe turning machine further cooperates with a curve adjusting program to correct curve errors caused in the following steps to reach a desired surface precision of the lens.

After cutting, the surface of the non-spherical lens is coated with hardening membranes to improve the quality of the lens, mostly to eliminate scattering phenomenon of the surface. The hardening membranes are made of material selected from the group comprising organic silicate or acrylic urethane. Methods for coating the hardening membranes are selectively dip coating or spin coating.

Because the hardening membrane easily forms in an uneven state whereby the surface does not achieve the desired surface precision, the thickness of the hardening membrane is measured in three dimensions and then the curve adjusting program is returned to remodify the surface of the lens by the CNC lathe turning machine. The desired surface precision of the large-scale is ø 150 mm within a varying range of 0.02 mm.

Lastly, to increase the transparency rate of the large-scale lens, anti-reflecting membranes coated on the hardening membranes to achieve a large-scale plastic lens having excellent focusing efficiency. The anti-reflecting membranes are made of material selected from the group comprising magnesium fluoride, silicon dioxide, and titanium dioxide. Methods of coating the anti-reflecting membranes are selectively vacuum steam plating, ionizing plating, plasma polymerization etc.

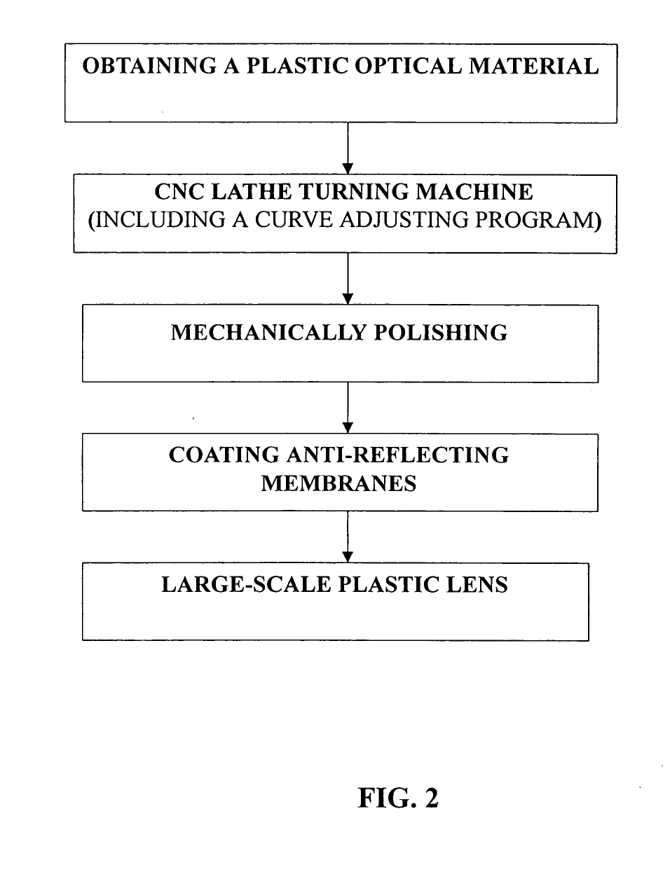

FIG. 2 shows a second embodiment of the method in accordance with the present invention that has the similar acts in comparison with the first one except the coating of the hardening membrane is replaced by mechanical polishing. The surface of the non-spherical lens is polished by a polishing wheel running a non-spherical path under CNC programs. The curve adjusting program cooperates with the CNC lathe turning machine to further modify the surface of the non-spherical lens to reach the desired surface precision. Lastly, the modified non-spherical lens is coated with anti-reflecting membranes to obtain the final large-scale plastic lens.

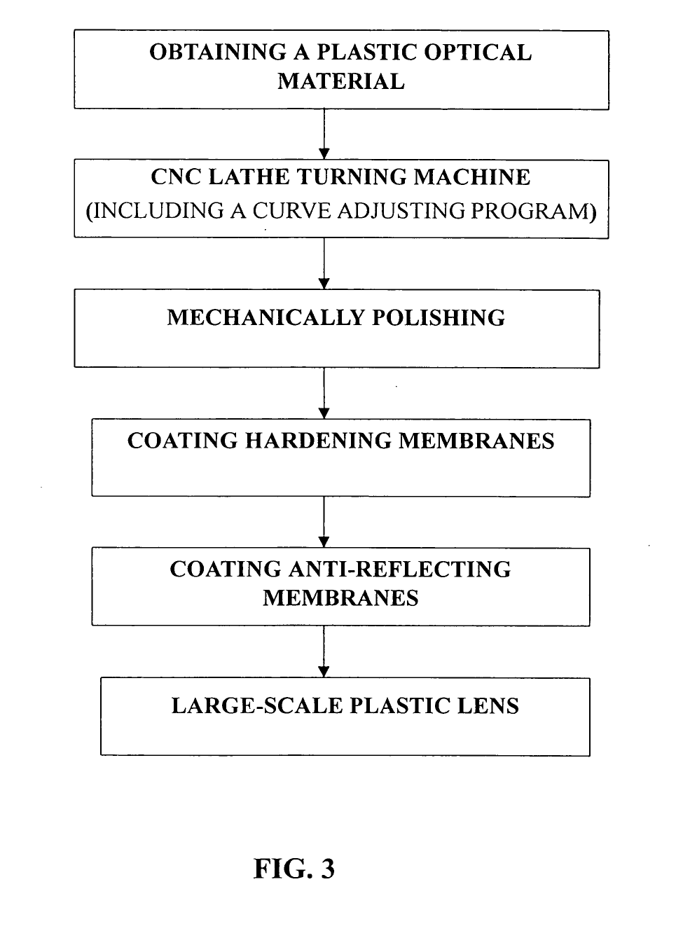

FIG. 3 shows a third embodiment of the method in accordance with the present invention that has the similar acts in comparison with the second embodiment except an additional coating of the hardening membranes is added after the mechanical polishing. The curve adjusting program still cooperates with the CNC lathe turning machine to further modify the surface of the non-spherical lens to reach the desired surface precision. Lastly, the modified non-spherical lens is coated with anti-reflecting membranes to obtain the final large-scale plastic lens.

In the methods for manufacturing large-scale plastic lens, several advantages are discovered:

1. By providing the accurate CNC lathe turning machine and the coating of hardening membrane or mechanical polishing, the large-scale plastic lens can be manufactured directly without combining multiple small spherical lenses together. Therefore, the manufacturing procedure of the large-scale lens is simplified to save time and molds are obviated to decrease manufacturing cost.

2. The accurate CNC lathe turning machine cooperates with the curve adjusting program to trim the surface of the non-spherical lens to reach accurate surface precision, therefore, the large-scale plastic lens has excellent focusing efficiency.

Even though numerous advantages of the present invention have been set forth in the foregoing description, the disclosure is illustrative only. Changes may be made in detail within the principles of the invention to the full extent indicated by the broad general meaning of the terms in which the appended claims are expressed.

1. A method for manufacturing large-scale plastic lens comprising the steps of:
obtaining a plastic optical material piece;
cutting the plastic optical material piece into a lens by use of an accurate CNC lathe turning machine that cooperates with a curve adjusting program to correct curve errors caused in following steps to reach a desired surface precision of the lens;
coating hardening membranes on surfaces of the lens; and
coating anti-reflecting membranes on the hardening membranes to achieve the large-scale plastic lens.

2. The method as claimed in claim 1, wherein the plastic optical material piece is made of polycarbonate plate.

3. The method as claimed in claim 1, wherein the plastic optical material piece is made of polymethyl methacrylate.

4. The method as claimed in claim 1, wherein the hardening membranes are formed by dip coating.

5. The method as claimed in claim 1, wherein the hardening membranes are formed by spin coating.

6. The method as claimed in claim 1, wherein the anti-reflecting membranes are made of material selected from the group comprising magnesium fluoride, titanium dioxide and silicon dioxide.

7. A method for manufacturing large-scale plastic lens comprising the steps of:
obtaining a plastic optical material piece;
cutting the plastic optical material piece into a lens by use of an accurate CNC lathe turning machine that cooperates with a curve adjusting program to correct curve errors caused in following steps to reach a desired surface precision of the lens;
mechanically polishing surfaces of the lens; and
coating anti-reflecting membranes on the surfaces of the lens to achieve the large-scale plastic lens.

8. The method as claimed in claim 7, wherein the plastic optical material piece is made of polycarbonate plate.

9. The method as claimed in claim 7, wherein the plastic optical material piece is made of polymethyl methacrylate.

10. The method as claimed in claim 7, wherein the anti-reflecting membranes are made of material selected from the group comprising magnesium fluoride, titanium dioxide and silicon dioxide.

11. A method for manufacturing large-scale plastic lens comprising the steps of:
obtaining a plastic optical material piece;
cutting the plastic optical material piece into a lens by use of an accurate CNC lathe turning machine that cooperates with a curve adjusting program to correct errors caused in following steps to reach a desired surface precision of the lens;
mechanically polishing surfaces of the lens;
coating hardening membranes on the surfaces of the lens; and
coating anti-reflecting membranes on the hardening membranes to achieve the large-scale plastic lens.

12. The method as claimed in claim 11, wherein the plastic optical material piece is made of polycarbonate plate.

13. The method as claimed in claim 11, wherein the plastic optical material piece is made of polymethyl methacrylate.

14. The method as claimed in claim 11, wherein the hardening membranes are formed by dip coating.

15. The method as claimed in claim 11, wherein the hardening membranes are formed by spin coating.

16. The method as claimed in claim 11, wherein the anti-reflecting membranes are made of material selected from the group comprising magnesium fluoride, titanium dioxide and silicon dioxide.
